(19) United States
(12) Patent Application Publication
(10) Pub. No.: US 2002/0087045 A1
(43) Pub. Date: Jul. 4, 2002

(54) Transparent disposable cover for patient transport

(76) Inventors: Haydee Chamorro-Perez, Bayamon, PR (US); Luis E. Ruiz, Trujillo Alto, PR (US)

Correspondence Address: Richard C. Litman, LITMAN LAW OFFICES, LTD., P.O. Box 15035, Arlington, VA, 22215, US

(21) Appl. No.: 09/752,770

(22) Filed: Jan. 3, 2001

(51) Int. Cl. A61G 10/00; E04H 15/10

(52) U.S. Cl. 600/21; 135/91

(57) ABSTRACT

A transparent, disposable cover for patients during their transport. The cover protects against cigarette smoke, air borne bacteria, dust, etc. The cover can vary in size and has multiple access panels held in place with VELCRO®. The cover may feature multiple bacterial filters. The cover will fit three types of holders: corner holders, “T” shaped frames, and a canopy frame. A disaster emergency cover and frame, and a utility cart cover are also embodiments of the present invention.

### BACKGROUND OF THE INVENTION

1. Field of the Invention

The present invention relates to special use covers. More particularly, the present invention relates to transparent disposable covers for use in the health care industry for patient and sterile materials transport.

2. Description of the Related Art

During recent years the continuous evolution of nursing on a day to day basis has been augmented in relation to quality service. Today's patients are educated in their rights and treatments.

All hospitals are liable for law suits related to patient care, and they must continuously protect themselves. For these reasons hospitals must provide the highest standard of quality nursing care. It is a time of transition for patients and Health Care Industry personnel to guarantee that all nursing care services are focused on the prevention and maintenance of an optimal state of health care that the patient deserves. Nosocomial Infection, i.e., infection acquired by patients who visit a health care facility is a serious problem. For example, Nosocomial Infection(NI) is a significant health problem in Brazil. Of eleven million hospital admissions per year and a rate of 5% to 10% NI in Brazilian hospitals it is estimated that there are between 550,000 to 1,100,000 cases per year in that country.

In addition, during 1998 the Center for Disease Control (CDC) published a revised Guideline for Infection Control for hospital personnel. This revision of the guideline has been expanded to include:

A. Recommendations for nonpatients' care personnel, both within and outside hospitals.

B. Management of exposures.

C. Prevention of transmission of infections in micro biological and biomedical laboratories due to the common use of latex barriers to prevent infections.

D. Prevention of latex hypersensitivity reactions.

As in the 1983 Guideline, readers are frequently referred to the Guideline for Isolation Precautions in Hospital and other published guidelines and recommendations that health care personnel may use when caring for a patient and handling patient equipment or specimens.

A few of the infections that can be crossed contaminated through (NI) transmission are: (1) Hepatitis B, and C, (2) HIV, (3) Conjunctivitis, (4) Diphtheria, (5) Gastroenteritis, (6) Rubella, (7) Tuberculosis, (8) Varicella, (9) Influenza, (10) Herpes simplex, (11) Menigococcal Disease, (12) Measles, and (13) Parvo Virus.

As a result of observing the vulnerability of exposure of patients and nonpatients to infectious diseases it has been determined that steps must be taken to provide a barrier or cover effective to protect these people from infection. Particularly, patients subjected to surgical procedure and those who have compromised immune systems need protection.

U.S. Pat. No. 4,948,154, issued Aug. 14, 1990, to Guggenheim describes a sterile cart cover that is transparent and provides limited access to the cart through multiple flaps secured with VELCRO®.

U.S. Pat. No. 4,224,936, issued Sep. 30, 1980, to Cox describes a patient isolator having a flexible plastic film supported by a frame with filtered inlet air.

U.S. Pat. No. 5,725,426, issued Mar. 10, 1998, to Alvarezl describes a tent-like drape of large enough capacity to serve as an operating room. The drape is suspended by hooks to outer support points. Purified air is provided to the interior. No floor or floor frame is provided.

U.S. Pat. No. 6,001,057, issued Dec. 14, 1999 to Bongiovanni et al. describes a self-contained isolation and environmental protection system for fielding a patient comprising an environmental control system and a containment enclosure fabricated from materials resistant to chemical and/or biological attack.

None of the above inventions and patents, taken either singularly or in combination, is seen to describe the instant invention as claimed. Thus a transparent disposable cover for patient transport solving the aforementioned problems is desired.

### SUMMARY OF THE INVENTION

The transport cover for patients of the present invention is particularly suited for those patients subjected to surgical procedures and those having immune system deficiencies. The patients who may benefit from the cover of the present invention include:

Patients submitted to surgical procedures.

Patients with a history of infections.

Patients to be transported to and from hospital wards.

Patients with immune deficiency.

Burn patients.

High-risk patients.

Transplant patients.

Implants patients.

Bone marrow transplant patients.

Patients affected by natural disasters. (To improvise a sterile field.)

The inventive cover provides the following desired results:

Prevents NI.

Prevents cross contamination.

Prevents exposure of contagious diseases.

Prevents exposure of infectious diseases to patients and nonpatients.

Provides security, trust and an indication that the institution is interested in the well-being of its patients, employees, and visitors.

may be provided both in a sterile or non sterile packing, depending upon its use.

Is effective as temporary isolation sites.

Is easy to use.

Is available in various sizes and disposable single use.

The inventive cover is a transparent, disposable cover that may be used on all types of patient transports in the health care industry. Postoperative patients will benefit directly due to the fact that they are more susceptible in acquiring infectious diseases during transport. The cover also protects the patient from contaminates such as cigarette smoke, air borne bacteria, and dust, etc.

The health care provider cannot determine who may be carrying an infectious disease, or who has entered an area that may be contaminated, by a visual inspection. The chances of acquiring NI are very high in a health care environment. The health care industry is responsible for the prevention of all types of infections in a hospital setting. The cost of a prolonged stay at a health care facility due to NI is very high. There is also the danger of permanent injury or death.

The inventive cover is provided in a variety of sizes and includes holders attachable to the patient transport as required. Access panels on the sides of the cover are held in place by VELCRO®.

The inventive cover may also be used as a transport cover in the transportation of sterile and non-sterile medical material or equipment. The front section of the transparent cover has an access panel which is held in place by VELCRO®. Accordingly, it is a principal object of the invention to provide a transparent, disposable drape system for a patient transport providing isolation of the patient within its interior.

It is another object of the invention to provide a drape system as above having access flaps to allow attending of the patient.

It is a further object of the invention to provide a drape system as above having VELCRO® mating strips located so as to allow easy separation of the access flaps from their respective walls.

Still another object of the invention is to provide a drape system as above having bacteria filters located in the walls, thereof.

It is yet another object of the invention to provide a transparent, disposable drape so sized and shaped to fit over a medical utility cart.

It is still another object of the invention to provide a drape system as above having VELCRO® mating strips located along the sides of an access flap for releasably securing the flap to its respective sidewall.

It is yet another object of the invention to provide a disaster emergency drape system having a rectangular frame defining a floor so sized as to accommodate a patient, and a disaster emergency drape having a top and opposing side walls and opposing end walls conforming to the rectangular frame and supported at each corner.

It is still another object of the invention to provide a disaster emergency drape system as above, having VELCRO® mating strips located along the sides of an access flap for releasably securing the flap to its respective sidewall.

It is an object of the invention to provide improved elements and arrangements thereof for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1A is an environmental, perspective view of a transparent disposable cover for patient transport according to the present invention.

FIG. 1B is a detail view of the corner holder of FIG. 1A.

FIG. 1C is a view in perspective of a universal I.V. holder attached to the corner holder of FIG. 1A.

FIG. 2A is an environmental, perspective view of the drape system of FIG. 1A, having “T” supports.

FIG. 2B is a side detail view in elevation of the “T” support of FIG. 2A.

FIG. 3A is an environmental, perspective view of the drape system of FIG. 1A, having a canopy holder.

FIG. 3B is a detail view of the canopy holder of FIG. 3A.

FIG. 4 is a perspective view of a drape system similar to that of FIG. 1A, having multiple bacterial filters.

FIG. 5 is a view in perspective of the disaster emergency drape system of the present invention.

FIG. 6 is an environmental, perspective view of a utility cart drape system of the present invention.

Similar reference characters denote corresponding features consistently throughout the attached drawings.

### DETAILED DESCRIPTION OF THE PREFERRED EMBODIMENTS

The present invention is a transparent, disposable cover for patients during their transport. The cover protects against cigarette smoke, air borne bacteria, dust, etc. Such a cover can vary in size and has multiple access panels held in place with VELCRO® mating strips. The cover may feature multiple bacterial filters. The cover will fit at least three types of holders, corner holders, “T”shaped frames, and a canopy frame. A disaster emergency cover and frame, and a utility cart cover are also embodiments of the present invention.

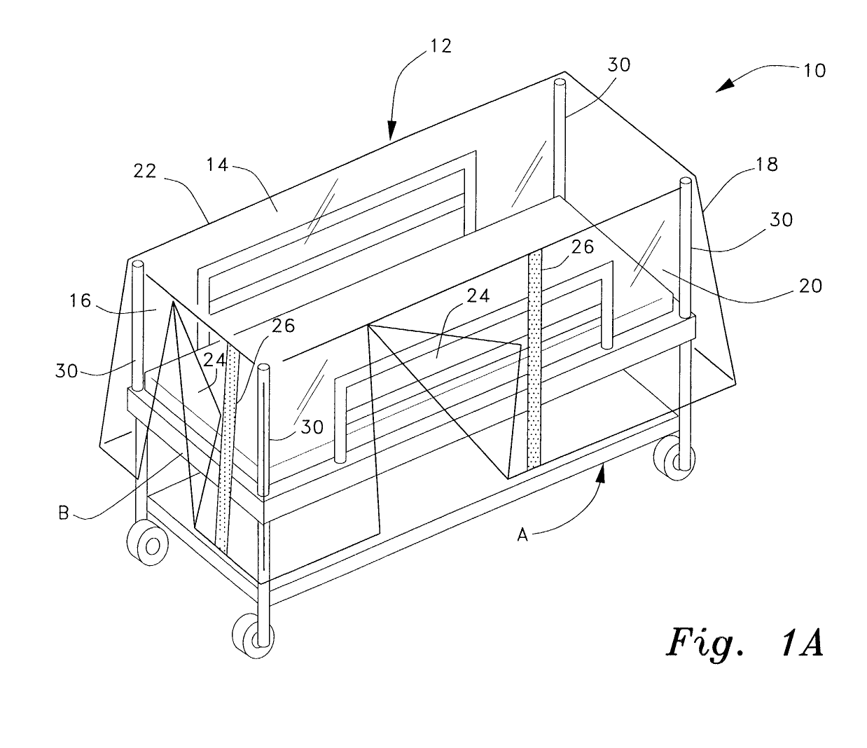

Referring to FIGS. 1A, 1B, and 1C, there is shown patient transport drape system 10 covering patient transport A having patient transport frame B. Patient transport drape system 10 includes patient transport drape 12 having drape top 14, drape first end wall 16, drape second end wall 18, drape first side wall 20 and patient transport second side wall 22. Access flaps 24 are located in side and end walls as desired, the access flaps having VELCRO® strips attaching along one side thereof to their respective walls such that the flaps may be easily and completely opened as desired. Patient transport drape 12 is supported at each corner by corner holders 30(see FIG. 1B) having insertable ends 32 which fit into standard patient transport frame B, drape 12 fitting over each corner holder 30. A universal I.V. holder 50(see FIG. 1C) may be mounted on one of the corner holders 30 as desired. The vertical corner holders of the present invention are preferably about 39 inches in installed vertical length.

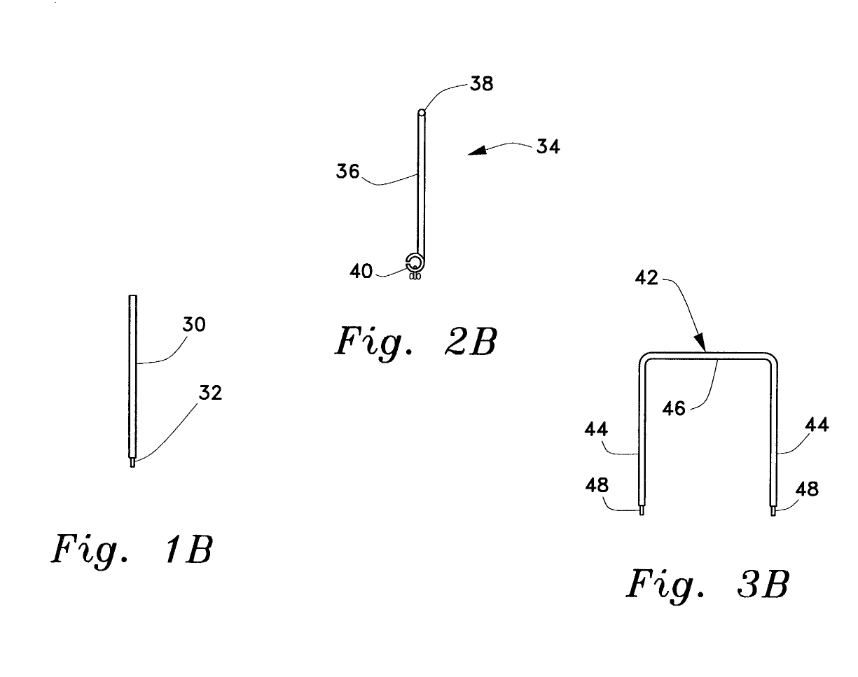

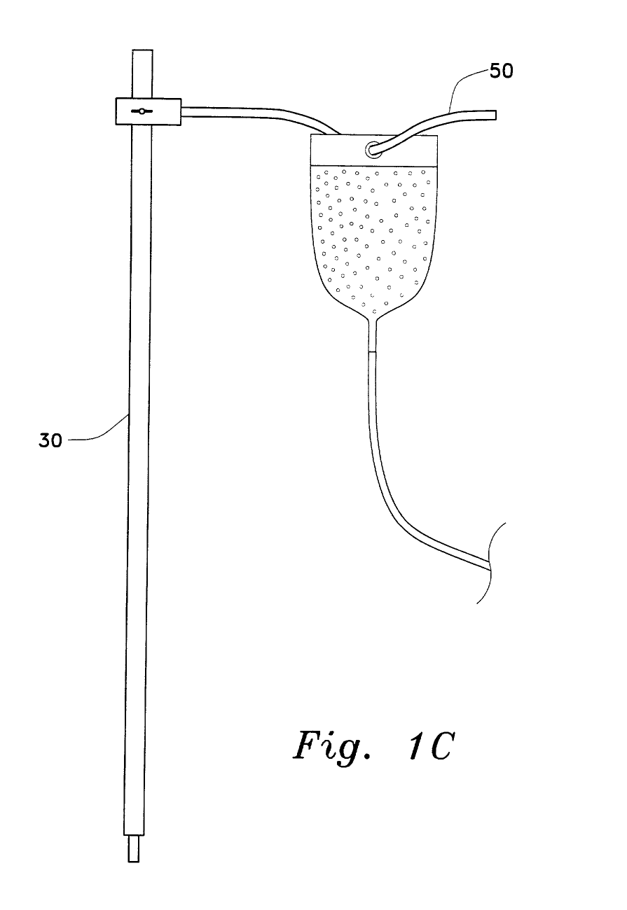

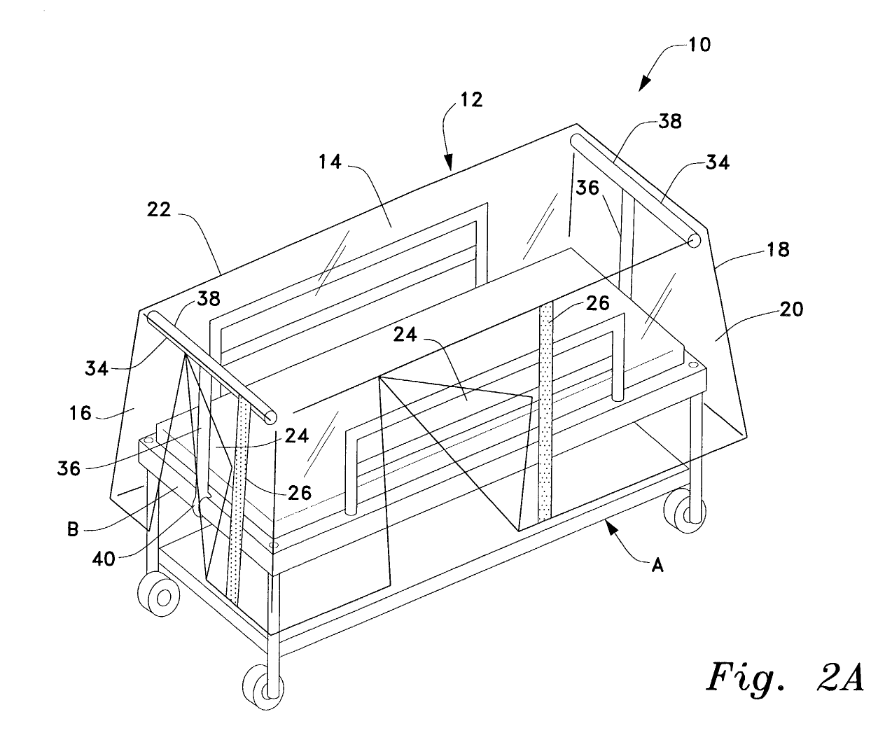

Referring to FIGS. 2A and 2b, there is shown the drape system 10 of FIG. 1 having a “T” shaped holder 34 comprising vertical shaft 36 and upper horizontal member 38, and attached at a central location along each end of patient transport frame B by “C” clamp 40 at its lower end. Drape 12 fits over each “T” shaped holder 34 in a manner similar to the corner holders 30 of FIG. !A. The “T” shaped holder of the present invention is about 39 inches in vertical length, and about 25 inches in width and has the ability to fit all patient transports by adjusting the “C” clamp at its base.

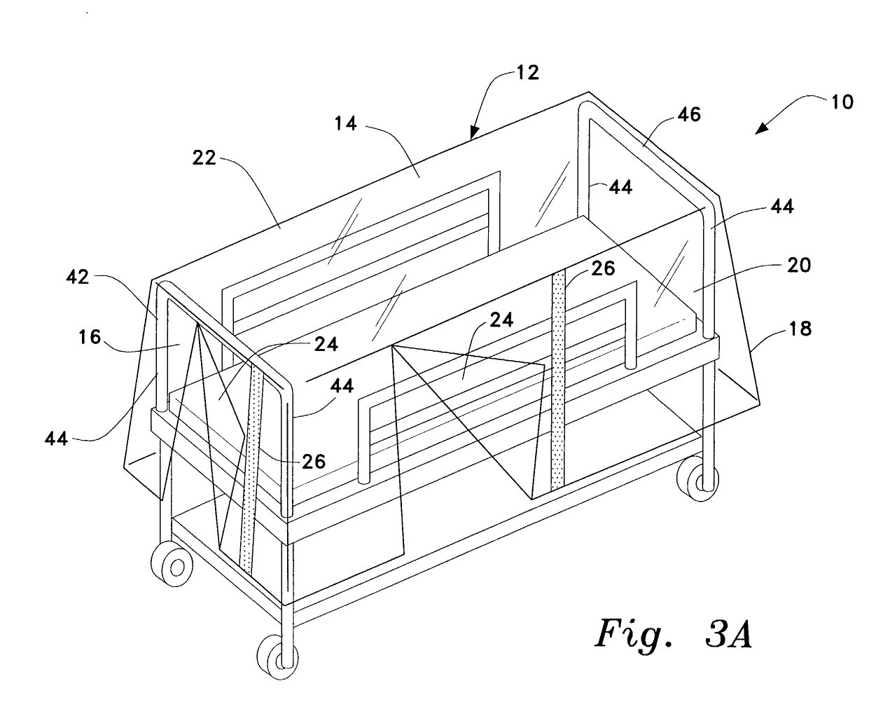

Referring to FIGS. 3A and 3B, there is shown the drape system 10 of FIG. 1 having a canopy holder frame 42 comprising frame uprights 44 joined at their upper end by upper horizontal member 46, and having canopy holder frame insertable ends 48 inserted at each end of patient transport frame B at the corners, thereof, in a manner similar to corner holders 30. Drape 12 fits over each canopy holder frame 42 in a manner similar to the “T” shaped holders 34 of FIG. 2A. A canopy holder according to the present invention is preferably about 39 inches in installed vertical length and from about 22½ inches to 25½ inches wide, depending on the width of the patient transport frame.

In operation, the desired drape supports are mounted on patient transport A and transport drape 21 is fitted over the supports and transport. The patient may be attended through access flaps 24 and an I.V. on universal holder 50 may be accessed for service. The patient may also be removed from patient transport A through any of the flaps 24.

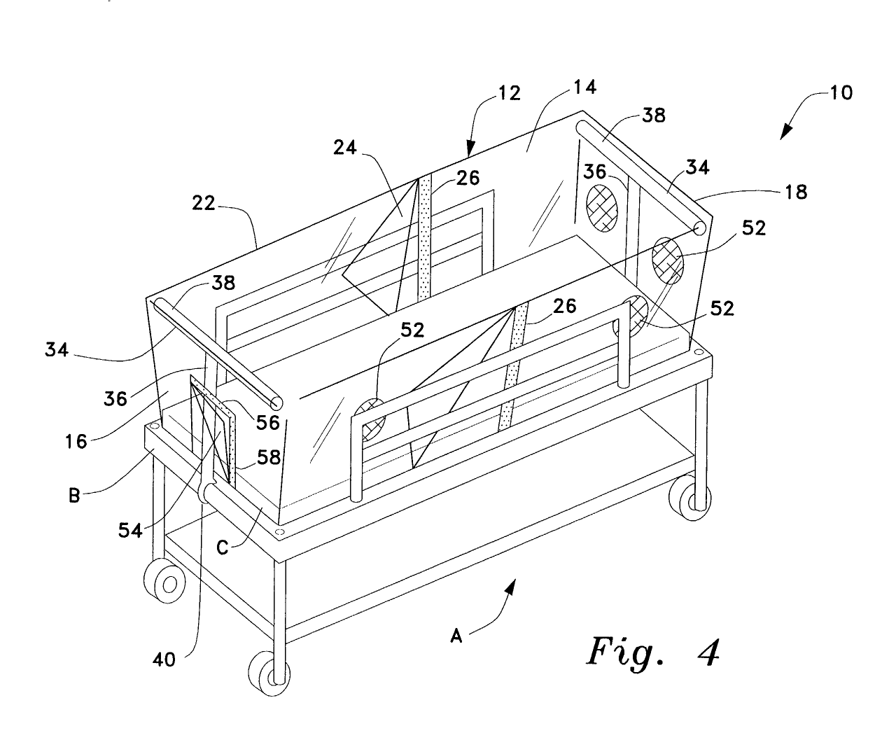

Referring to FIG. 4, there is shown a patient transport drape system having a transport drape similar to that of FIG. 1, with the some exceptions. The patient transport drape 12 in this embodiment features side access flaps which are releasably held in place along their vertical edge by VELCRO® strips or the equivalent, and having no unsecured opposite edge as in the access flaps of FIG. 1, thus providing a more secure interior and exterior environment. Also, the patient transport drape 12 lower perimeter is fitted around the mattress C of the patient transport A for similar reasons. A small end flap 54, is employed, centrally located in each of the lower, portions of end walls 16 and 18 and, releasably held in place by perimeter VELCRO® strips 56 and 58 to allow for limited access for attachment of “T” shaped holders 34 to patient transport frame B. Patient transport drape 12 also provides bacterial filters 52 located in the side walls 20 and 22, for the delivery of fresh sterile air to the patient, while protecting health workers and visitors from contamination by the patient. This embodiment provides a much more secure environment than those of FIG. 1, 2, and 3, and access to the patient is more restricted. If it is deemed unnecessary to have the drape 12 fitted under mattress C, corner holders 30 or canopy holder frames 42(see FIGS. 1 and 3, above) may be employed in place of “T” shaped holders 34.

In operation, the embodiment of FIG. 4 is deployed in a similar manner to the embodiments of FIGS. 1, 2, and 3, with the exception that drape 12 must be fitted around and under mattress C. Only the “T” holders 34 may be used and they are preferably installed by first inserting the respective “T” holders” vertical shafts through patient transport small end flaps 54 from the inner side of drape 12 to the outer side thereof and attached at each end to patient transport frame B by means of “C” clamps 40. The drape 40 may then be fitted around the mattress. If it is not deemed necessary, the drape 12 need not be fitted under mattress C, thus allowing easier erection of the patient transport drape system 10 with any of the supports described above.

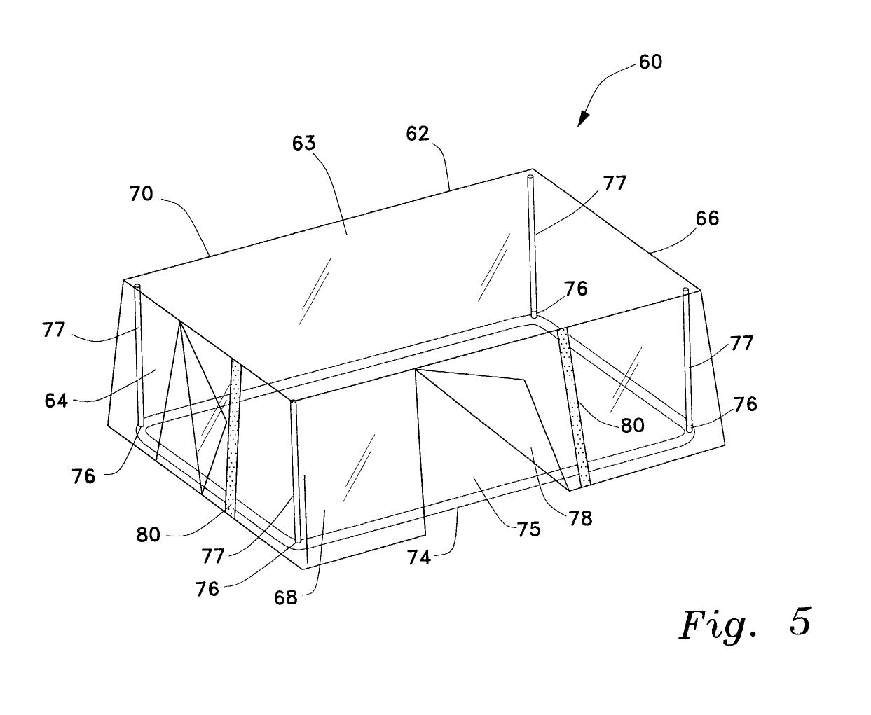

Referring to FIG. 5, there is shown a disaster emergency drape system 60 for use as a protected environment for patients and health care workers in a disaster environment. Drape disaster emergency drape 62 comprises disaster drape top 63, disaster drape first end wall 64, disaster drape second end wall 66, disaster drape first side wall 68, and disaster emergency drape second side wall 70. It is supported by corner holders 30 of appropriate length, having insertable ends 32(see FIGS. 1A and 1B), or canopy holder frames 42 of appropriate size, having insertable ends 42 (see FIGS. 3A and 3B), either supports being mounted on disaster emergency base frame 74 by means of upright receivers 76 at each of the four corners thereof. Disaster emergency floor 75 is attached about its periphery to base frame 74 and is made of any desired material. Floor to top emergency drape access flaps 78 are located in the drape walls as desired and at least one vertical flap side is removably attached to its respective wall by VELCRO® strips 80. The preferred overall size of the disaster emergency drape system is about 68″ long, by 27″ wide, and 25″ high, but may be of any desired size as desired. The disaster emergency drape system may be used on any flat terrain or floor, as required.

In operation, the disaster emergency frame, having floor 75 mounted thereon is placed on level terrain or a floor. Uprights 30 or canopy holder frames 42 are mounted into upright receivers 76 of frame 72. Disaster emergency drape 62 is then draped over the uprights 30 or canopy holder frames 42. Emergency drape access flaps 80 allow access to the interior of the disaster emergency drape system 60.

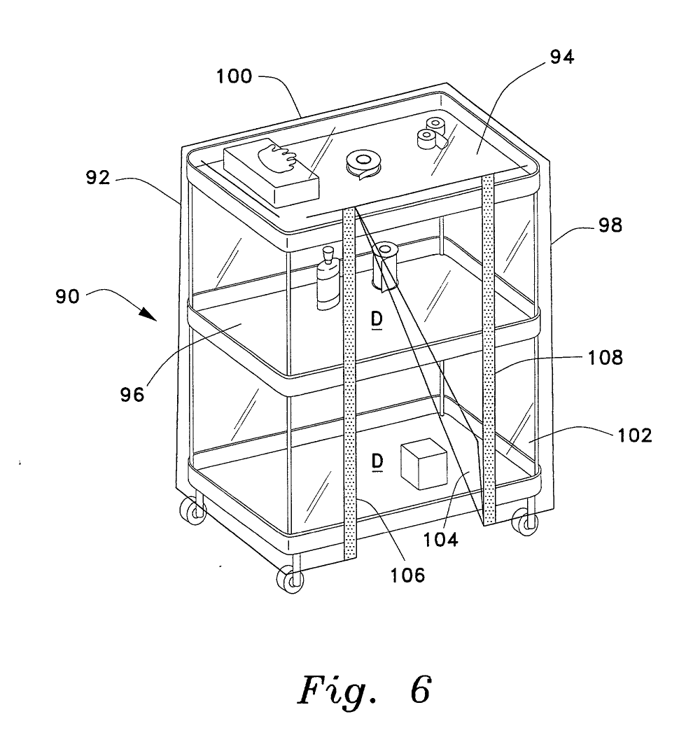

Referring to FIG. 6 there is shown a utility cart drape system 90 fitting over a utility transport cart for moving sterile material, surgical instruments, instruments cases, and bottles, etc. in a relatively sterile environment. Utility cart drape 92 comprises cart drape top 94, cart drape first side 96, cart drape second side 98, cart drape back 100, and cart drape front 102. Utility cart drape front access flap 104 is located in cart drape front 102 and is releasably held in place along its vertical sides thereto by cart drape front access flap first VELCRO® strip 106 and cart drape front access flap second VELCRO® strip 106 for easy access to the above-mentioned articles. The utility cart drape 92 is sized to fit over any standard utility cart and needs no additional support.

In operation, the appropriate sized utility transport drape is merely placed over the utility transport cart. Access to the cart for loading and unloading articles is made by opening front access flap 104 by separating one or both of first and second VELCRO® strips 106 and 108, loading or unloading desired articles, and then closing flap 104 and sealing the VELCRO® strips.

The transparent cover or drape of the present invention may be made of any suitable material such as polyethylene sheet or film. The drape supports and the disaster emergency floor frame may be made of any suitable material such as metal or plastic.

It is to be understood that the present invention is not limited to the embodiments described above, but encompasses any and all embodiments within the scope of the following claims.

We claim:

1. A transparent disposable drape system for a patient transport comprising:
a) a transparent, disposable drape having a top, two opposing ends, and two opposing sides and having a lower periphery; and
b) a support system for supporting said disposable drape above and around a frame of said patient transport forming an enclosure therebetween;
c) said support system being of such dimensions as to provide said enclosure with clearance above a patient resting on said patient transport.

2. The transparent disposable drape system for a patient transport wherein said support system provides an enclosure having adequate clearance to install a standard I.V. and universal holder for treatment of said patient.

3. The transparent disposable drape system of claim 2 wherein said support system is adapted for attachment of said universal I.V. holder.

4. The transparent disposable drape system of claim 2, wherein said support system comprises vertical corner holders having insertion portions at their respective lower ends for insertion into each of four corners of said patient transport frame.

5. The transparent, disposable patient transport drape system of claim 2, wherein said support system comprises a “T” shaped holder located at each end of said patient transport frame and having a vertical shaft and an upper horizontal member forming said “T” shape, and a “C” clamp at a lower end of said vertical shaft for attachment to said transport frame near the midpoint of each end thereof.

6. The transparent, disposable patient transport drape system of claim 2, wherein said support system comprises a canopy holder frame located at each end of said patient transport frame, each canopy holder frame having two vertical shafts separated at their upper ends by a horizontal member, each vertical shaft having an insertion portion located at their lower ends, respectively, for insertion into each of four corners of said patient transport frame.

7. The transparent, disposable patient transport drape system of claim 1, further comprising at least one access flap located in at least one of said opposing side walls and opposing end walls opening and extending vertically upward from said lower periphery to said top.

8. The transparent, disposable patient transport drape system of claim 7, wherein at least one vertical side of said flap is removably secured to its respective wall.

9. The transparent, disposable patient transport drape of claim 8, wherein said at least one vertical side of said flap is removable secured to its respective wall by mating VELCRO® strips.

10. The transparent, disposable patient transport drape of claim 9, having at least one flap in each of one of said side walls and said end walls.

11. The transparent, disposable patient transport drape of claim 2, having a bacterial filter in at least one of said side walls and said end walls.

12. The transparent, disposable patient transport drape of claim 12, having said lower periphery of said drape fitted beneath a mattress located on said patient transport, an closeable access hole centrally located near the lower periphery of each end wall, and a “T” shaped holder located at each end of said patient transport frame and having a vertical shaft and an upper horizontal member forming said “T” shape and having a “C” clamp at a lower end of said vertical shaft for attachment to said transport frame near the midpoint of each end thereof, said vertical shaft extending from the interior of said enclosure and through said closeable access hole for mounting onto said patient transport frame.

13. A transparent disposable drape system for a medical utility cart comprising:
a) a transparent, disposable drape having a top, two opposing end walls, a front wall and an opposing rear wall, and having a lower periphery;
b) said transparent disposable drape being of such dimensions as to fit over a medical utility cart.

14. The transparent, disposable drape system for a medical utility cart of claim 13, further comprising at least one access flap located in at least one of said opposing front wall and said back wall and extending vertically upward from said lower periphery to said top.

15. The transparent, disposable drape system for a medical utility of claim 14, wherein at least one vertical side of said flap is removably secured to its respective wall.

16. The transparent, disposable drape system for a medical utility cart of claim 8, wherein said at least one vertical side of said flap is removably secured to its respective wall by mating VELCRO® strips.

17. A transparent disposable drape system for a disaster emergency comprising:
a) a transparent, disposable drape having a top, two opposing ends, and two opposing sides, and having a lower periphery;
b) a rectangular frame having insertion points at each corner thereof and defining a floor of such length and width as to accommodate a patient;
c) a floor mounted on said rectangular frame; and
d) a support system for supporting said disaster emergency drape above and around said rectangular frame forming an enclosure, therebetween;
d) said support system being of such dimensions as to provide said enclosure with clearance above a patient resting on said floor.

18. The disaster emergency drape system of claim 17 wherein said support system comprises vertical corner holders having insertion portions at their respective lower ends for insertion into each of four corners of said rectangular frame.

19. The disaster emergency drape system of claim 17 wherein said support system comprises a canopy holder frame located at each opposing end of said rectangular frame, each canopy holder frame having two vertical shafts separated at their upper ends by a horizontal member, each vertical shaft having an insertion portion located at their lower ends, respectively, for insertion into each of four corners of said rectangular frame.

20. The transparent, disaster emergency, disposable drape system of claim 17, further comprising at least one access flap located in at least one of said opposing side walls and said end walls and extending vertically upward from said lower periphery to said top, wherein at least one vertical side of said flap is removably secured to its respective wall by mating VELCRO® strips.
